(19) United States
(12) Patent Application Publication
(10) Pub. No.: US 2007/0120741 A1
(43) Pub. Date: May 31, 2007

(54) Ultra wide bandwidth planar antenna

(75) Inventor: Kuo-Hua Tseng, Mei-Nung Chen (TW)

Correspondence Address: BANNER & WITCOFF, LTD., 1100 13th STREET, N.W., SUITE 1200, WASHINGTON, DC, 20005-4051, US

(73) Assignee: UNIVERSAL SCIENTIFIC INDUSTRIAL CO., LTD., Tsao-Tun Chen (TW)

(21) Appl. No.: 11/345,490

(22) Filed: Feb. 2, 2006

(30) Foreign Application Priority Data
Nov. 28, 2005 (TW) 09141693

(51) Int. Cl. H01Q 1/38

(52) U.S. Cl. 343/700 MS

(57) ABSTRACT

A planar antenna includes a dielectric substrate, first and second radiating elements, a feeding strip, and a grounding unit. The first radiating element is formed on the dielectric substrate. The second radiating element is formed on the dielectric substrate and is connected to the first radiating element. The feeding strip is formed on the dielectric substrate and extends from the second radiating element. The grounding unit is formed on the dielectric substrate, is physically disconnected from the first and second radiating elements and the feeding strip, and includes a pair of grounding elements that are physically disconnected from each other and that are disposed on opposite sides of the feeding strip.

### BACKGROUND OF THE INVENTION

1. Field of the Invention

This invention relates to a planar antenna, more particularly to an ultra wide bandwidth planar antenna.

2. Description of the Related Art

In U.S. Pat. No. 6,914,573, there is disclosed a conventional planar antenna that is operable within the ultra wide bandwidth (UWB). The conventional planar antenna includes a radiating element, a feeding strip that extends from the radiating element, and a grounding element that is disposed around and that is physically disconnected from the radiating element and the feeding strip.

The aforementioned conventional planar antenna is disadvantageous in that, based from experimental results, when it is operated within the UWB, it has a voltage standing wave ratio of greater than three at the higher frequencies of the UWB.

### SUMMARY OF THE INVENTION

Therefore, the object of the present invention is to provide a planar antenna that can overcome the aforesaid drawback of the prior art.

According to the present invention, a planar antenna, which is operable within the ultra wide bandwidth, comprises a dielectric substrate, first and second radiating elements, a feeding strip, and a grounding unit. The dielectric substrate has a surface. The first radiating element is formed on the surface of the dielectric substrate, and has opposite first and second sides. The second radiating element is formed on the surface of the dielectric substrate, and has opposite first and second sides. The first side of the second radiating element is connected to the second side of the first radiating element. The feeding strip is formed on the surface of the dielectric substrate and extends from the second side of the second radiating element. The grounding unit is formed on the surface of the dielectric substrate, is physically disconnected from the first and second radiating elements and the feeding strip, and includes a pair of grounding elements that are physically disconnected from each other and that are disposed on opposite sides of the feeding strip.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of the first preferred embodiment of a planar antenna according to the present invention;

FIG. 2 is a plot illustrating a voltage standing wave ratio of the first preferred embodiment;

FIG. 3 is a plot illustrating a radiation pattern of the first preferred embodiment on the H-plane when operated at 5 GHz;

FIG. 4 is a plot illustrating a radiation pattern of the first preferred embodiment on the E-plane when operated at 5 GHz;

FIG. 5 is a schematic view of the second preferred embodiment of a planar antenna according to the present invention;

FIG. 6 is a plot illustrating a voltage standing wave ratio of the second preferred embodiment;

FIG. 7 is a schematic view of the third preferred embodiment of a planar antenna according to the present invention;

FIG. 8 is a plot illustrating a voltage standing wave ratio of the third preferred embodiment;

FIG. 9 is a schematic view of the fourth preferred embodiment of a planar antenna according to the present invention; and

FIG. 10 is a plot illustrating a voltage standing wave ratio of the fourth preferred embodiment.

### DETAILED DESCRIPTION OF THE PREFERRED EMBODIMENTS

Before the present invention is described in greater detail, it should be noted that like elements are denoted by the same reference numerals throughout the disclosure.

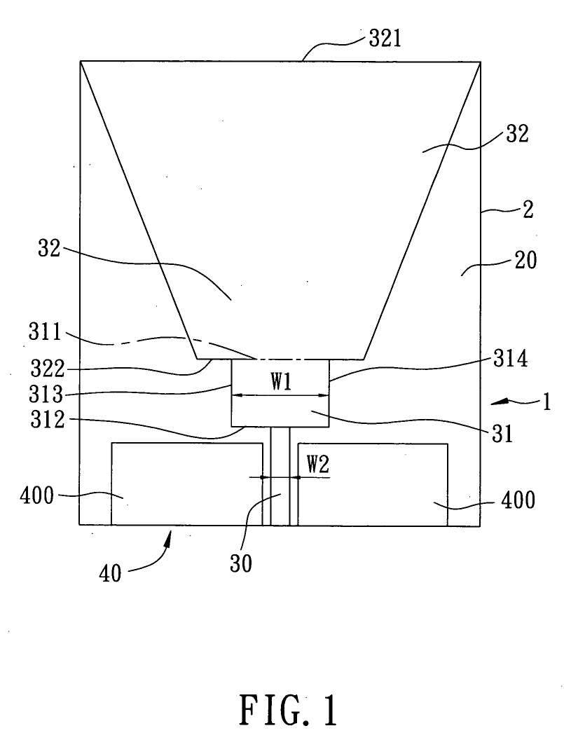

Referring to FIG. 1, the first preferred embodiment of a planar antenna 1 according to this invention is shown to include a dielectric substrate 2, first and second radiating elements 32, 31, a feeding strip 30, and a grounding unit 40.

The planar antenna 1 of this embodiment is operable within the ultra wide bandwidth, i.e., between 3.1 GHz and 10.6 GHz.

In this embodiment, the dielectric substrate 2 is available from Rogers Corp. under model no. RO4003C. In an alternative embodiment, the dielectric substrate 2 is a FR-4 substrate.

The first radiating element 32 is formed on a surface 20 of the dielectric substrate 2. In this embodiment, the first radiating element 32 is generally trapezoidal in shape, and has opposite first and second sides 321, 322. The first side 321 of the first radiating element 32 is parallel to and has a length that is longer than that of the second side 322 of the first radiating element 32.

The second radiating element 31 is formed on the surface 20 of the dielectric substrate 2. In this embodiment, the second radiating element 31 is generally rectangular in shape, and has opposite first and second sides 311, 312, and opposite third and fourth sides 313, 314. The third and fourth sides 313, 314 of the second radiating element 31 have a length that is shorter than that of the first and second sides 311, 312 of the second radiating element 31. The first side 311 of the second radiating element 31 is connected to the second side 322 of the first radiating element 32.

It is noted that the first radiating element 32 has an area that is greater than that of the second radiating element 31.

The feeding strip 30 is formed on the surface 20 of the dielectric substrate 2, and extends from the second side 312 of the second radiating element 31. In this embodiment, the feeding strip 30 is generally rectangular in shape.

It is noted that the width (W1) of the second radiating element 31 is greater than the width (W2) of the feeding strip 30.

The grounding unit 40 is formed on the surface 20 of the dielectric substrate 2, and is physically disconnected from the first and second radiating elements 32, 31 and the feeding strip 30. In this embodiment, the grounding unit 40 includes a pair of grounding elements 400 that are physically disconnected from each other, that are generally rectangular in shape, and that are respectively disposed on opposite sides of the feeding strip 30.

Preferably, each of the first and second radiating elements 32, 31, the feeding strip 30, and the grounding elements 400 is made of copper foil.

It is noted that each of the first and second radiating elements 32, 31, the feeding strip 30, and the grounding elements 400 is formed by providing first a copper foil on the surface 20 of the dielectric substrate 2, and then by patterning and etching the copper foil. Accordingly, manufacturing costs for the planar antenna 1 of this invention can be reduced.

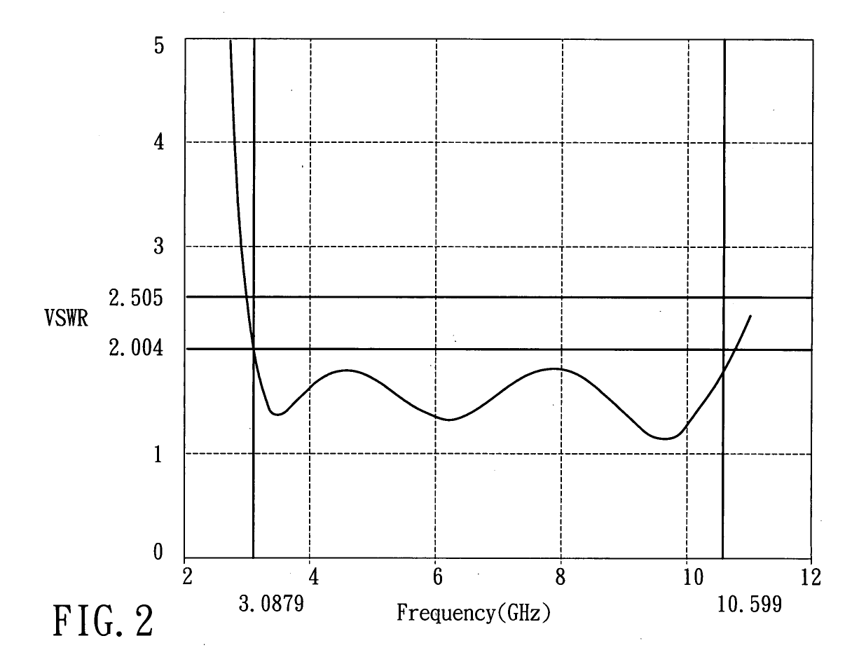

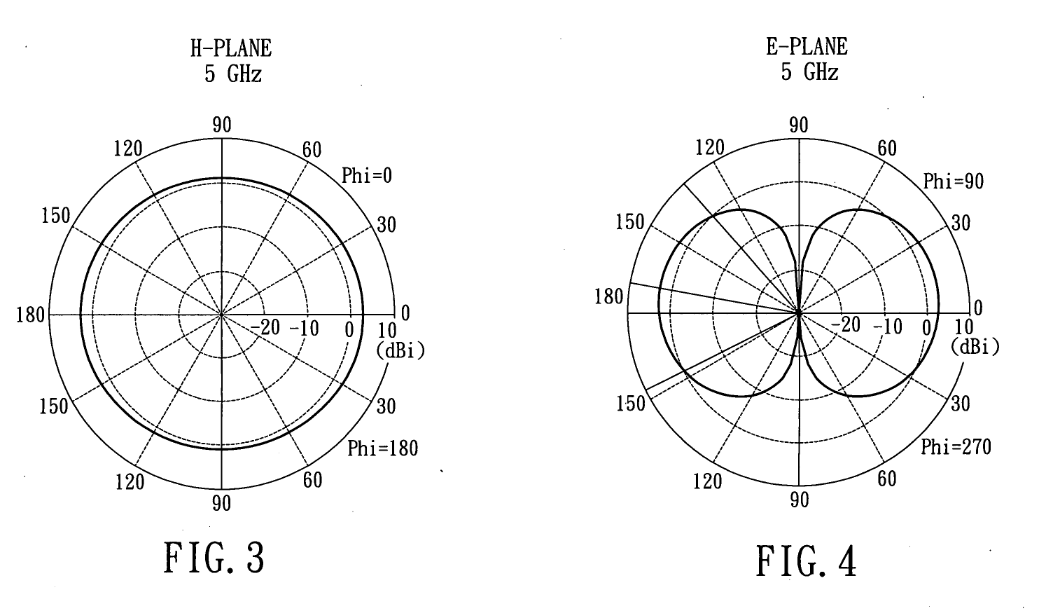

Based on simulated results, as illustrated in FIG. 2, the planar antenna of this embodiment achieves a voltage standing wave ratio (VSWR) of less than 2.004 when operated within 3.1 GHz and 10.6 GHz. Moreover, the planar antenna of this invention has a doughnut shaped radiation pattern (not shown) when operated at 5 GHz. FIGS. 3 and 4 illustrate radiation patterns of the planar antenna of this invention on the H-plane (i.e., xy plane) and the E-plane (i.e., xz plane) when operated at 5 GHz.

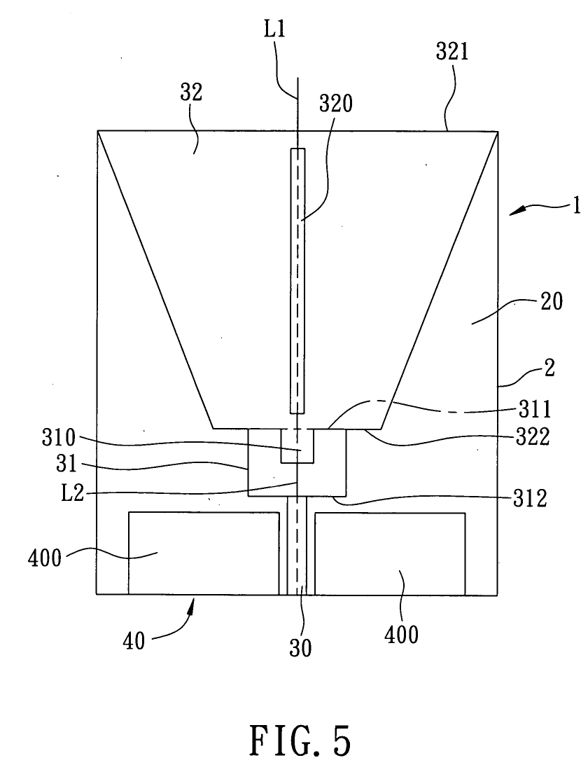

FIG. 5 illustrates the second preferred embodiment of a planar antenna 1 according to this invention. When compared with the previous embodiment, the first radiating element 32 is formed with a first slot 320 therethrough. The first slot 320 is elongated, and extends along a center line (L1) of the first radiating element 32 between the first and second sides 321, 322 of the first radiating element 32. Moreover, the second radiating element 31 is formed with a second slot 310 therethrough. The second slot 31 is generally rectangular in shape, and extends along a center line (L2) of the second radiating element 31, which is collinear with the center line (L1) of the first radiating element 32, from the first side 311 toward the second side 312 of the second radiating element 31.

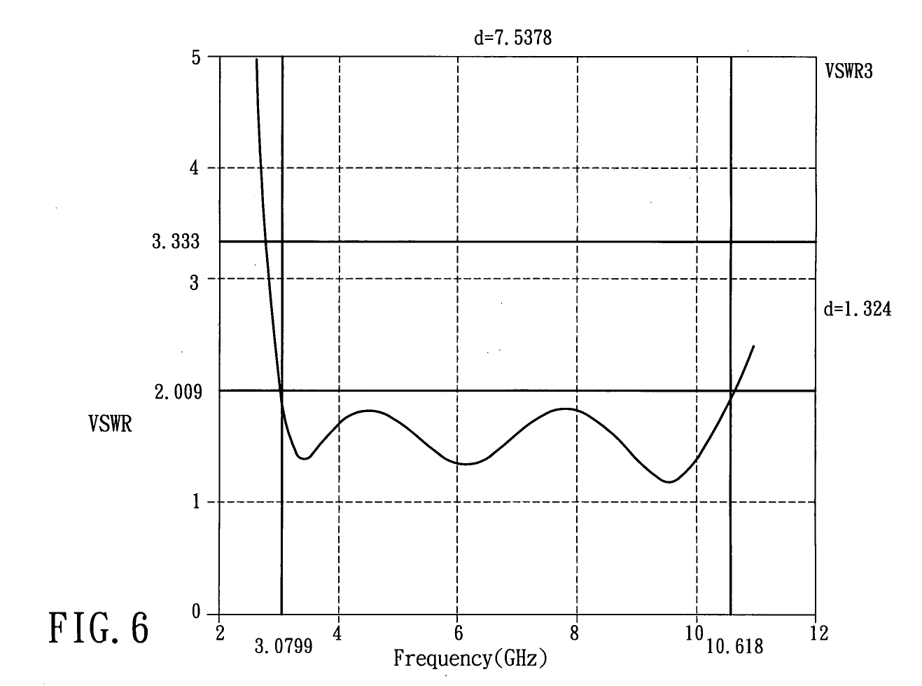

Based on simulated results, as illustrated in FIG. 6, the planar antenna of this embodiment achieves a VSWR of less than 2.009 when operated within 3.0799 GHz and 10.618 GHZ.

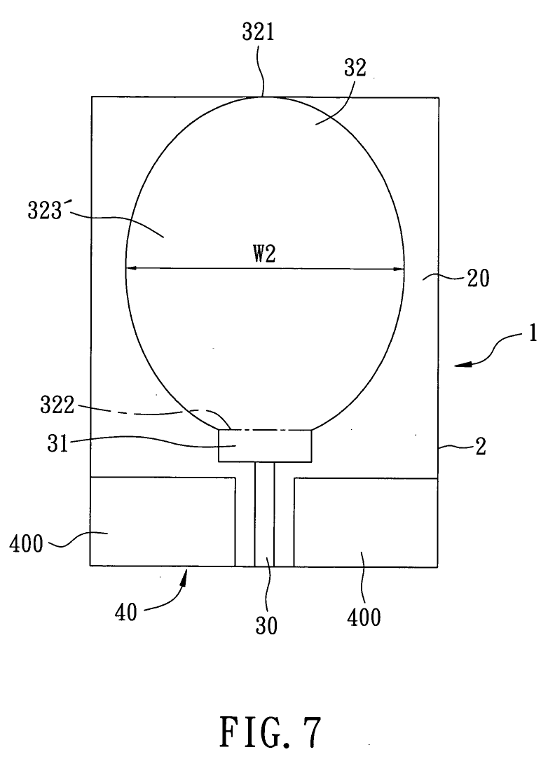

FIG. 7 illustrates the third preferred embodiment of a planar antenna 1 according to this invention. When compared to the first embodiment, the first radiating element 32 is substantially elliptical in shape.

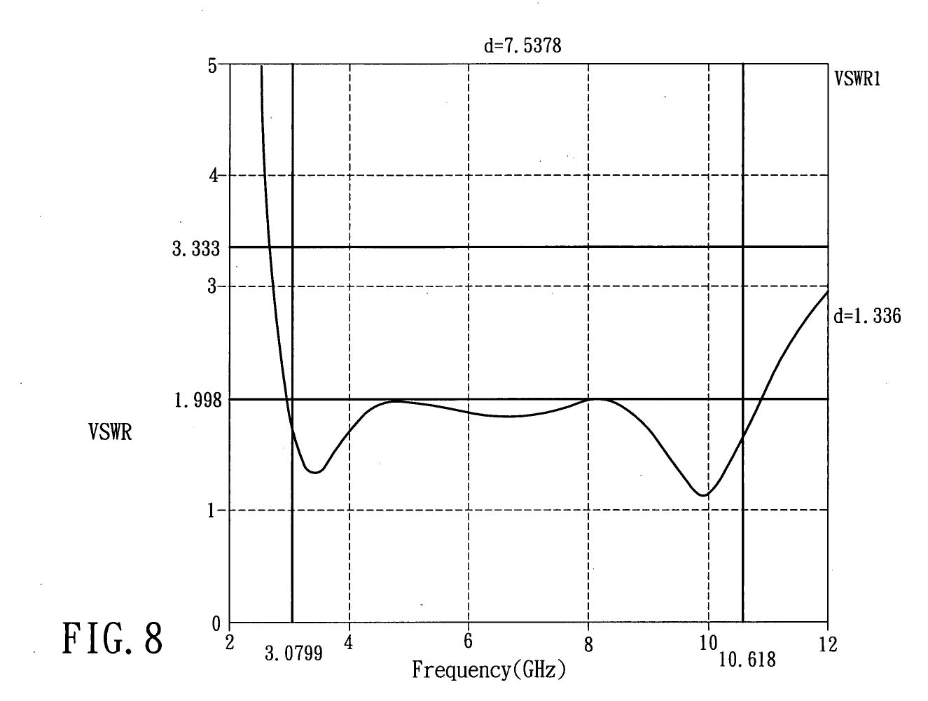

Based on simulated results, as illustrated in FIG. 8, the planar antenna of this embodiment achieves a VSWR of less than 1.998 when operated within 3.0799 GHz and 10.618 GHz.

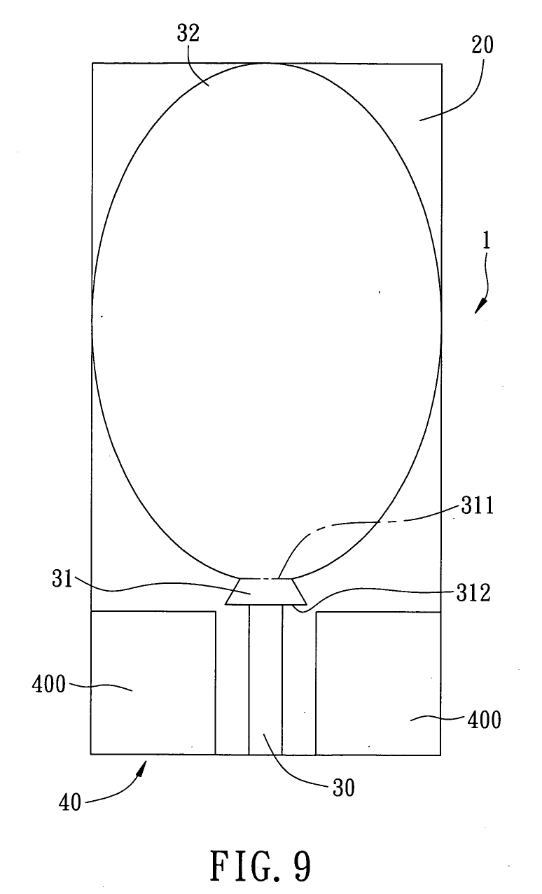

FIG. 9 illustrates the fourth preferred embodiment of a planar antenna 1 according to this invention. When compared with the third embodiment, the second radiating element 31 is generally trapezoidal in shape. The first side 311 of the second radiating element 31 is parallel to and has a length that is shorter than that of the second side 312 of the second radiating element 31.

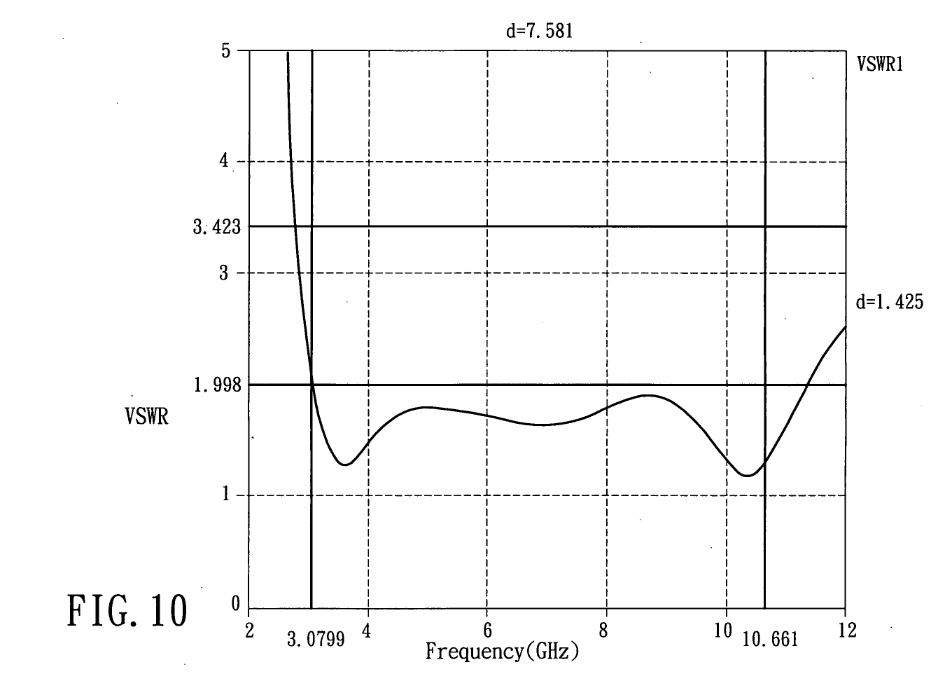

Based on simulated results, as illustrated in FIG. 10, the planar antenna of this embodiment achieves a VSWR of less than 1.998 when operated within 3.0799 GHz and 10.661 GHz.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A planar antenna operable within the ultra wide bandwidth, comprising:
a dielectric substrate having a surface;
a first radiating element formed on said surface of said dielectric substrate, and having opposite first and second sides;
a second radiating element formed on said surface of said dielectric substrate, and having opposite first and second sides, said first side of said second radiating element being connected to said second side of said first radiating element;
a feeding strip formed on said surface of said dielectric substrate, and extending from said second side of said second radiating element; and
a grounding unit formed on said surface of said dielectric substrate, physically disconnected from said first and second radiating elements and said feeding strip, and including a pair of grounding elements that are physically disconnected from each other and that are disposed on opposite sides of said feeding strip.

2. The planar antenna as claimed in claim 1, wherein said first radiating element has an area greater than that of said second radiating element.

3. The planar antenna as claimed in claim 1, wherein said second radiating element has a width that is greater than that of said feeding strip.

4. The planar antenna as claimed in claim 1, wherein said first radiating element is generally trapezoidal in shape, said first side of said first radiating element being parallel to and having a length that is longer than that of said second side of said first radiating element.

5. The planar antenna as claimed in claim 4, wherein said second radiating element is generally rectangular in shape, and further has third and fourth sides, each of which has a length shorter than that of each of said first and second sides of said second radiating element.

6. The planar antenna as claimed in claim 4, wherein said first radiating element is formed with a first slot therethrough, said first slot extending along a center line of said first radiating element between said first and second sides of said first radiating element.

7. The planar antenna as claimed in claim 6, wherein said second radiating element is formed with a second slot therethrough, said second slot extending along a center line of said second radiating element, which is collinear with the center line of said first radiating element, from said first side toward said second side of said second radiating element.

8. The planar antenna as claimed in claim 1, wherein said first radiating element is substantially elliptical in shape.

9. The planar antenna as claimed in claim 8, wherein said second radiating element is generally rectangular in shape, and further has a pair of third and fourth sides, each of which has a length shorter than that of each of said first and second sides of said second radiating element.

10. The planar antenna as claimed in claim 8, wherein said second radiating element is generally trapezoidal in shape, said first side of said second radiating element being parallel to and having a length that is shorter than that of said second side of said second radiating element.

11. The planar antenna as claimed in claim 1, wherein each of said first and second radiating elements, said feeding strip, and said grounding elements of said grounding unit is made of copper foil.
